(19) United States
(12) Patent Application Publication
(10) Pub. No.: US 2014/0013925 A1
(43) Pub. Date: Jan. 16, 2014

(54) FLUTES

(71) Applicant: Maximilian Spencer Clissold, Kowloon (HK)

(72) Inventor: Maximilian Spencer Clissold, Kowloon (HK)

(73) Assignee: NUVO INSTRUMENTAL (ASIA) LTD, Kowloon (HK)

(21) Appl. No.: 14/008,516

(22) PCT Filed: Mar. 8, 2012
(86) PCT No.: PCT/IB12/00439

§ 371 Date: Sep. 27, 2013

(30) Foreign Application Priority Data
Mar. 29, 2011 (HK) 11103146

(51) Int. Cl. G10D 9/02

(52) U.S. Cl. CPC G10D 9/02
USPC 84/384

(57) ABSTRACT

A lip plate for a flute, the lip plate including an air guide positionable adjacent an embouchure hole of the flute when the lip plate is attached to the flute wherein the air guide is adapted for directing a stream of air from a user's mouth in a direction relative to the embouchure hole to enable the flute to be played.

### TECHNICAL FIELD

The present invention relates to improvements in musical instruments such as flutes.

### BACKGROUND OF THE INVENTION

Traditionally western concert type flutes have been made from metals such as nickel, silver, gold and platinum based on the perception that such materials contribute to the sound quality produced by playing the flute. The use of such metals together with the intricate design configuration of traditional western concert type flutes also contributes to the relatively high cost of manufacture. Repair costs are similarly expensive due to the degree of specialised skill and delicacy required in disassembling and reassembling the component parts of the flute.

The design and construction of traditional western concert type flutes also contributes to the difficulties experienced by beginner players, particularly children, in learning to play the instrument. Firstly, metal flutes tend to be heavy and unwieldy making it difficult for children to hold the instrument securely and steadily in relation to their lips. This makes tone production very difficult for children. Due to the layout and intricacy of the flute keys, which were historically designed for use by adults, it is also awkward for a child's finger's to reach and operate such keys. Furthermore, it is difficult for the child and/or beginner, to initially learn to control how air flow is directed from the mouth toward the embouchure hole suitable for generating a tone. In view of the above difficulties initially faced by the beginner, the desire to practice and learn is adversely affected, and there is a tendency for the beginner to give up learning to play the flute at an early stage.

### SUMMARY OF THE INVENTION

The present invention seeks to alleviate at least one of the above-described problems.

The present invention may involve several broad forms. Embodiments of the present invention may include one or any combination of the different broad forms herein described.

In a first broad form, the present invention provides an air guide for a flute, the air guide being positionable adjacent an embouchure hole of the flute wherein the air guide is adapted for directing a stream of air from a user's mouth in a direction relative to the embouchure hole to enable the flute to be played. Advantageously, by alleviating the difficulty experienced by a beginner in learning to blow into the embouchure hole correctly to produce notes, the beginner is able to focus attention upon learning other aspects of flute play, without being discouraged at an early stage.

Preferably, the air guide may include at least one of a tubular and a U-shaped configuration.

Preferably, the air guide may include a first end adapted for engagement with the user's mouth and a second end positionable adjacent the embouchure hole via which the air stream exiting the air guide is directed in the direction relative to the embouchure hole.

Preferably, the air guide may include a surface configured to substantially complement a shape contour of a lip of the user when the user's mouth is engaged with the first end of the air guide.

Preferably, the air guide may include a polymer resin material.

Furthermore, the use of polymer resin to produce the first embodiment lip plate means that it is a more robust and versatile

Typically, the polymer resin may include at least one of an Acrylonitrile butadiene styrene and a Polyoxymethylene material.

Preferably, the air guide may include a releasable attachment means adapted for releasably attaching the air guide to the flute.

Preferably, the releasable attachment means may include at least one of a snap-fitting attachment means, an adhesive attachment means, a friction-fitting attachment, a clamping attachment means, an elastic attachment means and a screw-thread type attachment means.

Preferably, the snap-fitting attachment means may include a groove adapted for receiving a protrusion disposed on the flute so as to releasably attach the air guide to the flute.

Preferably, the air guide may include a portion defining a lip plate for the flute.

Preferably, the portion defining the lip plate for the flute may be integrally formed with the air guide.

Preferably, the releasable attachment means may be disposed on the portion defining the lip plate for the flute.

Preferably, the air guide may be adapted for releasable attachment to a head joint of the flute upon which the embouchure hole of the flute is located.

Preferably the air guide may include a locating means for locating the air guide in a substantially fixed position relative to the flute when the air guide is releasably attached to the flute. Typically, the locating means may include the releasable attachment means. Preferably, the locating means may include a protrusion extending from the portion defining the lip plate, the protrusion being shaped to substantially complement a contour of a recess disposed on the flute. Also preferably, the protrusion may include an annular channel adapted for receiving an o-ring, the o-ring providing an air-tight seal between the portion defining the lip plate and the flute when the air guide is releasably attached to the flute.

In a second broad form, the present invention provides a lip plate including an air guide positionable adjacent an embouchure hole of the flute when the lip plate is attached to the flute wherein the air guide is adapted for directing a stream of air from a user's mouth in a direction relative to the embouchure hole to enable the flute to be played.

Preferably, the air guide may include at least one of a tubular and a U-shaped configuration.

Preferably, the air guide may include a first end adapted for engagement with the user's mouth and a second end positionable adjacent the embouchure hole via which the air stream exiting the air guide is directed in the direction relative to the embouchure hole.

Preferably, the lip plate may include a surface configured to substantially complement a shape contour of a lip of the user when the user's mouth is engaged with the first end of the air guide.

Preferably, the lip plate may include a polymer resin material. Typically, the polymer resin may include at least one of an Acrylonitrile butadiene styrene and a Polyoxymethylene material. Advantageously, the use of polymer resin alleviates manufacturing and repair costs and may provide a more robust component part for a flute which is less susceptible to damage, particularly in the hands of a child.

Preferably the lip plate may include a releasable attachment means for releasably attaching the lip plate to the flute. Typically, the releasable attachment means may include at least one of a snap-fitting attachment means, an adhesive attachment means, a friction-fitting attachment, a clamping attachment means, an elastic attachment means and a screw-thread type attachment means.

Preferably, the snap-fitting attachment means may include a groove disposed in the lip plate adapted for receiving a protrusion disposed on the flute so as to releasably attach the lip plate to the flute.

Preferably, the lip plate may be adapted for releasable attachment to a head joint of the flute upon which the embouchure hole of the flute is located.

Preferably, the lip plate may include a locating means for locating the lip plate in a substantially fixed position relative to the flute when the lip plate is releasably attached to the flute. Typically, the locating means includes the releasable attachment means. Preferably, the locating means may include a protrusion extending from the lip plate, the protrusion being shaped to substantially complement a contour of a recess disposed on the flute.

Preferably, the protrusion may include an annular channel adapted for receiving an o-ring, the o-ring providing an air-tight seal between the lip plate and the flute when the lip plate is releasably attached to the flute.

In a third broad form, the present invention provides a flute including:

an elongate barrel;

an embouchure hole disposed in a surface of the barrel, the embouchure hole being adapted to allow air flow from a user's mouth into the elongate barrel;

a plurality of tone holes disposed along a surface of the barrel and a plurality of corresponding keys operable by the user to selectively open and close the plurality of tone holes;

wherein at least one of the elongate barrel and at least one of the plurality of keys includes a polymer resin material.

Preferably, the polymer resin material may include at least one of an Acrylonitrile butadiene styrene and a Polyoxymethylene material. Advantageously, the use of polymer resin alleviates manufacturing and repair costs and may provide a more robust component part for a flute which is less susceptible to damage, particularly in the hands of a child. The user of polymer resin also results in production of a flute which is less heavy than if manufactured using metal and is therefore better suited to being lifted and handled by a child.

Preferably, the elongate barrel may include a main body, and at least one of a head joint releasably attachable to a first end of the main body, and, a foot joint releasably attachable to a second end of the main body.

Preferably, the embouchure hole may be disposed on the head joint.

Preferably, the flute may include a means for releasably attaching at least one of the plurality of keys to the elongate barrel.

Preferably, the means for releasably attaching at least one of the plurality of keys to the elongate barrel may be adapted for providing pivotable movement of the at least one key relative to the elongate barrel to enable opening and closing of a corresponding tone hole. Advantageously, the keys are able to be relatively easily attached and detached to and from the elongate barrel of the flute to enable repair and maintenance. Moreover, where the component parts are formed from polymer resin, compared to relatively expensive metals, the options for performing cleaning are more flexible due to the robustness of the polymer resin material. This is in stark contrast to the time and expense involved in utilising specialist technicians to disassemble, repair, and re-assemble more intricately constructed traditional metal based flutes.

Preferably the flute includes a biasing means adapted for biasing at least one of the plurality of keys into the opened position when the at least one key is releasably attached to the elongate barrel, the biasing means including a polymer resin arm extending from the at least one key.

Preferably, the polymer resin arm may be integrally formed with the at least one key.

Preferably, the polymer resin arm may be receivable in a slot disposed on the elongate barrel when the at least one key is releasably attached to the flute.

Preferably, the main body of the flute may include a key and a corresponding tone hole adapted to enable playing of a D# note without attachment of a foot joint.

Preferably, at least one of the plurality of keys may include a pad for providing a seal between the at least one key and a corresponding tone hole when the at least one key is arranged in the closed position relative to the corresponding tone hole.

Preferably, the key pad may include a rubber material.

Preferably, the key pad may include a tail adapted for friction-fitting engagement with a slot disposed on the at least one key.

Preferably the flute may include a key extension adapted for releasable attachment to at least one of the plurality of keys, the key extension being shaped and dimensioned to reduce a distance required for a user's finger to reach the at least one key. Advantageously, the key extension may assist in alleviating the awkwardness and discomfort experienced by a child or a beginner in reaching for certain keys on the flute.

Preferably, the key extension may be releasably attachable to the at least one key by at least one of a friction fitting attachment means, a snap-fitting attachment means, an adhesive attachment means, a clamping means, and screw-thread type attachment.

Preferably, at least one of the plurality of keys may include a releasably attachable cap for engaging with the user's finger when the key is being operated.

Preferably, at least one of the plurality of keys may include a recess adapted for receiving an insert.

Preferably, at least one of the key extension, the cap and the insert may be adapted to include indicia indicative of at least one of a colour, an alphanumeric symbol, and a musical note symbol.

Preferably, the flute may include a lip plate in accordance with the second broad form of the present invention.

In a fourth broad form, the present invention provides a key for a flute as described in accordance with the third broad form of the present invention.

In a fifth broad form, the present invention provides a key extension for a flute as described in accordance with the third broad form of the present invention.

In a sixth broad form, the present invention provides a main body of a flute as described in accordance with the third broad form of the present invention.

In a seventh broad form, the present invention provides a main body of a flute including a tone hole disposed on a surface of the main body, and a corresponding key operable by a user to selectively open and close the tone hole in order to play a D# note without requiring attachment of a foot joint.

In an eighth broad form, the present invention provides a flute including

a main body having a D# key adapted for playing of a D# note; and

a foot joint including key work overhanging an end of the foot joint, the first end of the foot joint being adapted for releasable attachment to the main body wherein, when releasably attached, the D# key of the main body is positioned relative to the key work of the foot joint to provide a layout and configuration which is substantially consistent with a layout and configuration provided by attachment of a standard main body of a flute without a D# key to a standard foot joint having a D# key.

Preferably, the flute includes a polymer resin material.

Preferably, the flute includes a bayonet-fit type attachment means for releasably attaching the foot joint to the main body.

Preferably, the foot joint includes two tone holes and two corresponding keys.

Preferably, the overhanging key work includes a pivot rod and a pinky key.

Preferably, the pivot rod includes a notch adapted for receiving a protrusion disposed on the main body when the foot joint is releasably attached to the main body.

In a ninth broad form, the present invention provides a main body of a flute having a D# key adapted for playing a D# note, the main body of the flute being adapted for releasable attachment to an end of a foot joint having key work overhanging the end of the foot joint, wherein when releasably attached, the D# key of the main body is positionable relative to the key work of the foot joint to provide a layout and configuration which is substantially consistent with a layout and configuration provided by attachment of a standard main body of a flute without a D# key to a standard foot joint having a D# key.

In a tenth broad form, the present invention provides a foot joint of a flute having key work overhanging an end of the foot joint, the end of the foot joint being adapted for releasable attachment to a main body of the flute having a D# key disposed thereon for playing a D# note, wherein when releasably attached, the D# key of the main body is positionable relative to the key work of the foot joint to provide a layout and configuration which is substantially consistent with a layout and configuration provided by attachment of a standard main body of a flute without a D# key to a standard foot joint having a D# key.

In an eleventh broad form, the present invention provides a method of producing a flute including the step of providing an air guide positionable adjacent an embouchure hole of the flute wherein the air guide is adapted for directing a stream of air from a user's mouth in a direction relative to the embouchure hole to enable the flute to be played.

In a twelfth broad form, the present invention provides a method of playing a flute, including the step of positioning an air guide adjacent an embouchure hole of the flute wherein the air guide is adapted for directing a stream of air from a user's mouth in a direction relative to the embouchure hole to enable the flute to be played.

In a thirteenth broad form, the present invention provides a method of producing a flute including the steps of:
(i) forming a key on a main body of the flute, the key being adapted for playing a D# note; and
(ii) forming a foot joint having key work overhanging an end of the foot joint, the end of the foot joint being adapted for releasable attachment to the main body;

wherein, when releasably attached, the D# key of the main body is positioned relative to the key work of the foot joint to provide a layout and configuration which is substantially consistent with a layout and configuration provided by attachment of a standard main body of a flute without a D# key to a standard foot joint having a D# key.

### BRIEF DESCRIPTION OF THE DRAWINGS

The present invention will become more fully understood from the following detailed description of a preferred but non-limiting embodiment thereof, described in connection with the accompanying drawings, wherein:

FIGS. 1(a) to 1(f) show bottom, rear, top, front, first side and second side orthogonal views respectively of a first embodiment lip plate for releasable attachment to a flute embodiment;

FIG. 2 shows a perspective view of the first embodiment lip plate for releasable attachment to the flute embodiment;

FIG. 3 shows the flute embodiment in exploded view including a head joint a main body and a foot joint which are adapted for bayonet attachment to form the elongate barrel;

FIG. 4 shows an assembled view of the flute embodiment;

FIGS. 5(a)-5(f) show bottom, rear, top, front, first side and second side orthogonal views respectively of the main body of the flute embodiment;

FIG. 6 shows a perspective view of the main body of the flute embodiment;

FIGS. 7(a)-7(f) show bottom, rear, top, front, first side and second side orthogonal views respectively of the foot joint of the flute embodiment;

FIG. 8 shows a perspective view of the foot joint of the flute embodiment;

FIG. 9 shows a top perspective magnified view of the first embodiment lip plate adjacent the head joint of the flute embodiment;

FIG. 10 shows a bottom perspective magnified view of the first embodiment lip plate detached from the head joint of the flute embodiment in a position adjacent the embouchure hole of the head joint;

FIG. 11 shows a top perspective magnified view of the first embodiment lip plate releasably attached to the head joint of the flute embodiment;

FIG. 12 shows a top perspective view of a further lip plate embodiment having a standard lip plate configuration in a detached position from the head joint adjacent the embouchure hole;

FIG. 13 shows a side view of the first embodiment lip plate with an internal structure of the first embodiment lip plate represented by solid lines and shading;

FIG. 14 shows an exemplary view of keys releasably attachable to the main body of the flute embodiment in a detached position;

FIG. 15 shows a further exemplary view of keys releasably attachable to the main body of the flute embodiment in a detached position;

FIG. 16 shows an exemplary view of keys of the flute embodiment with caps and key extensions detached from respective keys of the flute embodiment;

### DETAILED DESCRIPTION OF PREFERRED EMBODIMENTS

Preferred embodiments of the present invention will now be described below with reference to the accompanying drawings.

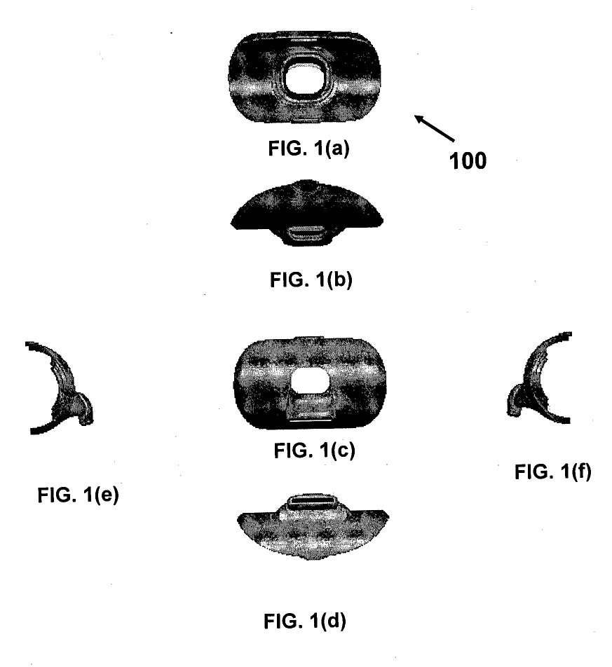

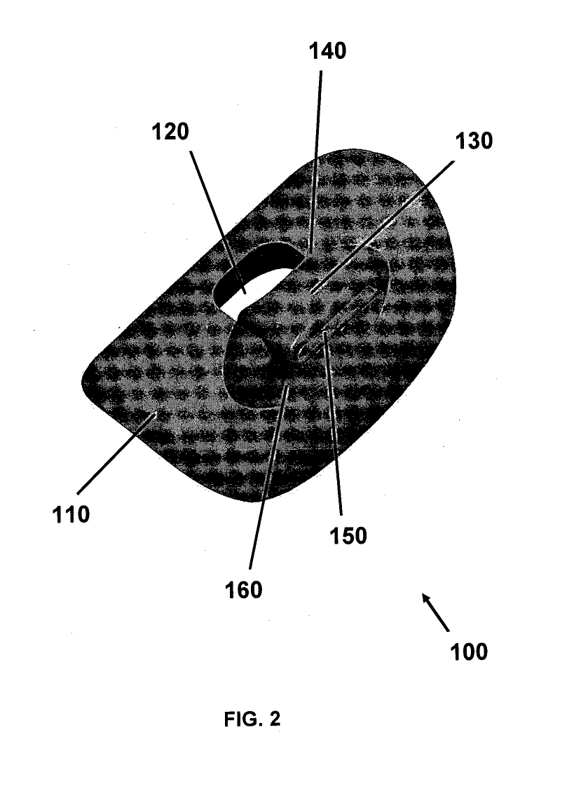

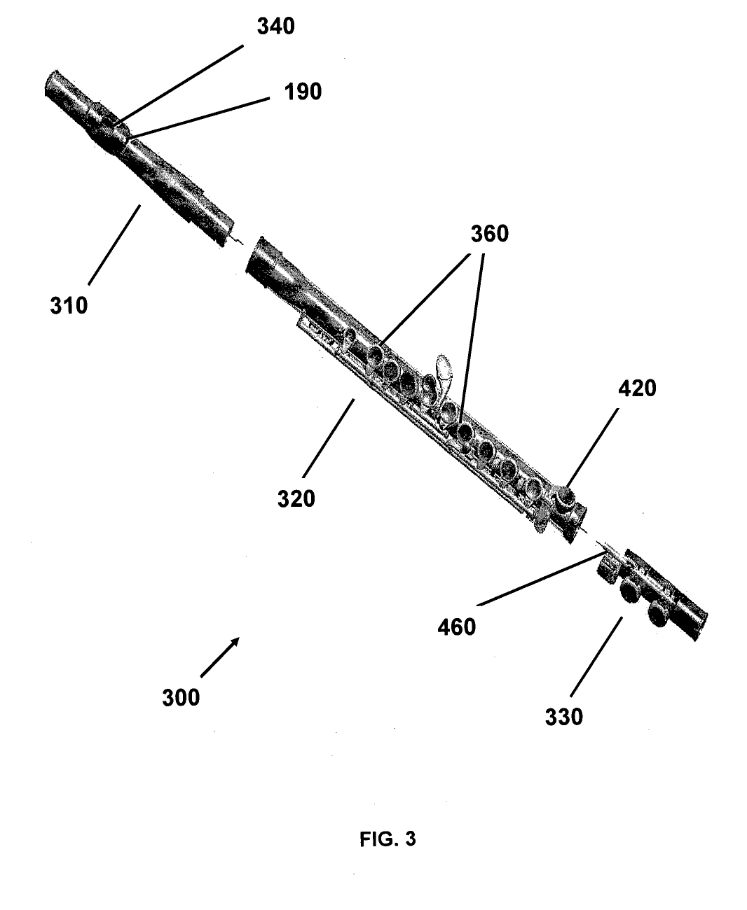

A first embodiment lip plate (100) is shown in FIGS. 1(a)-1(f) and FIG. 2 which is releasably attachable to a flute embodiment (300) depicted in FIGS. 3, 4, 14, 15 and 16. The flute (300) comprises an elongate barrel with an embouchure hole (340) disposed in a surface of the elongate barrel at a first end, a plurality of tone holes (350) disposed along a length of the elongate barrel, and a plurality of corresponding keys (360) operable by a user to selectively open or closed corresponding tone holes (350) to play notes.

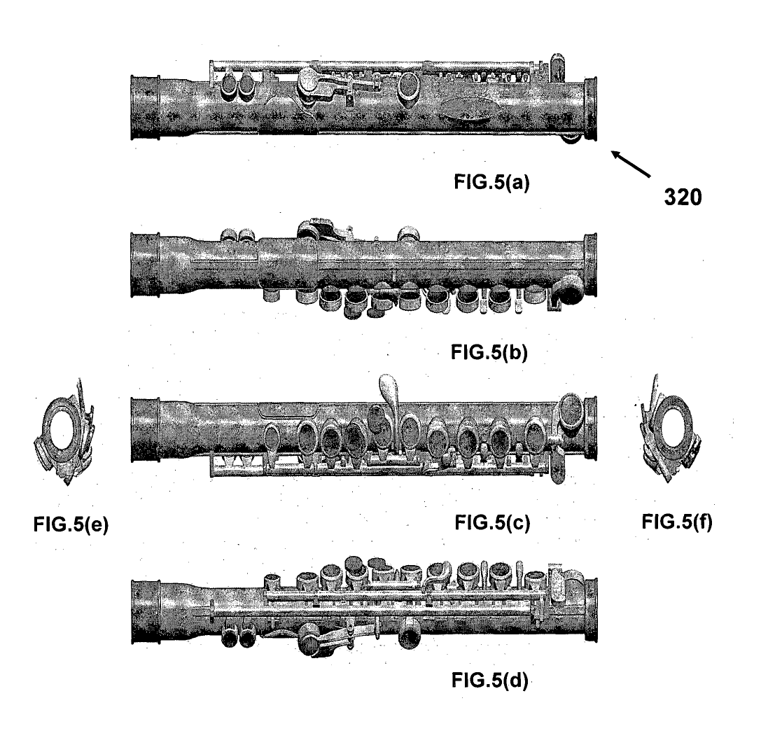

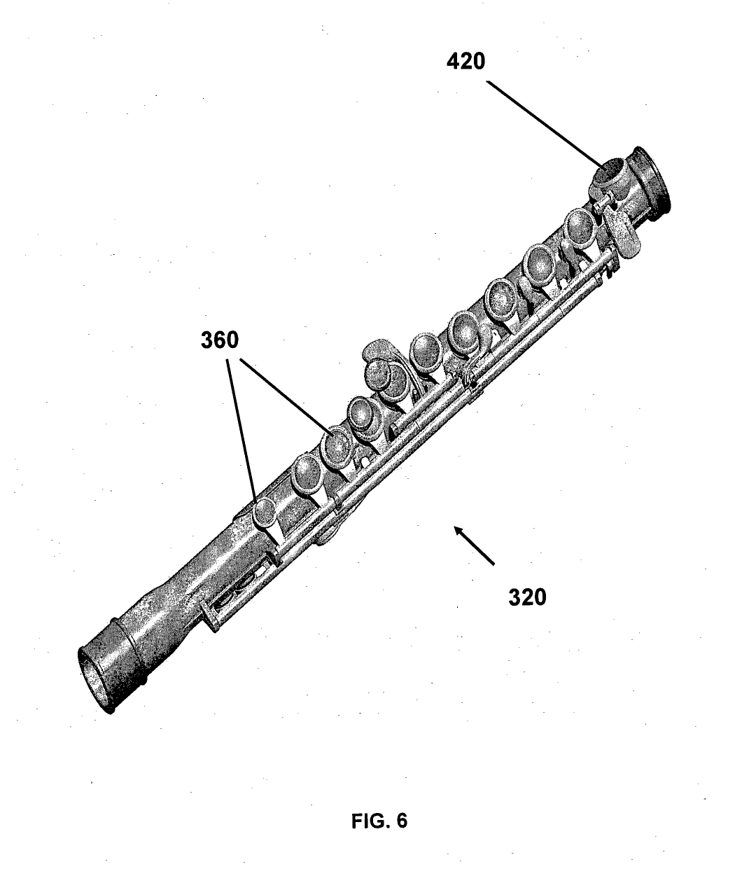

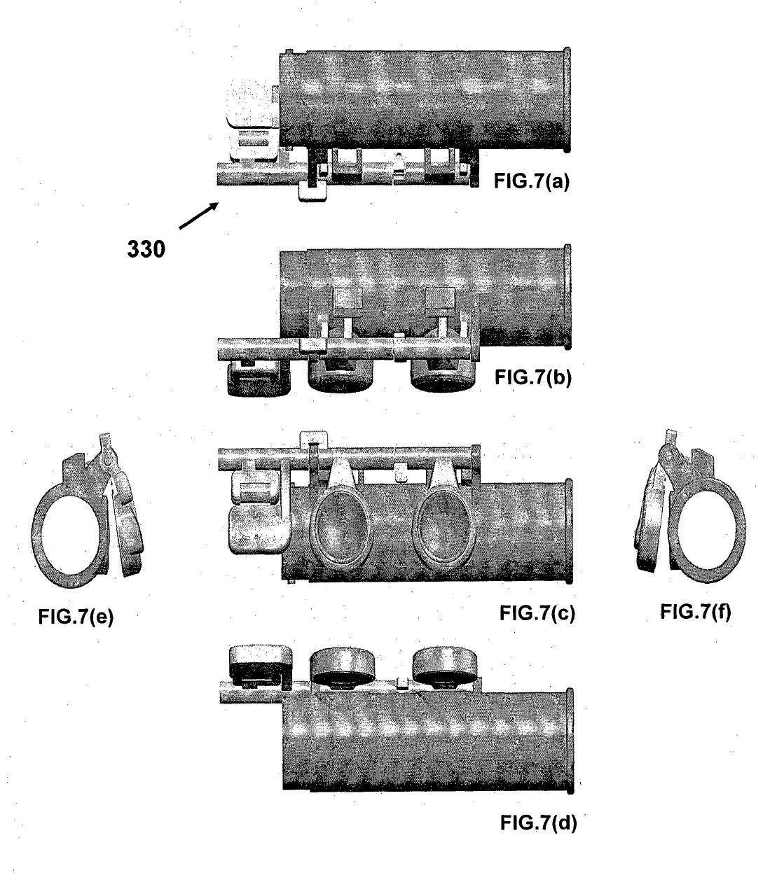

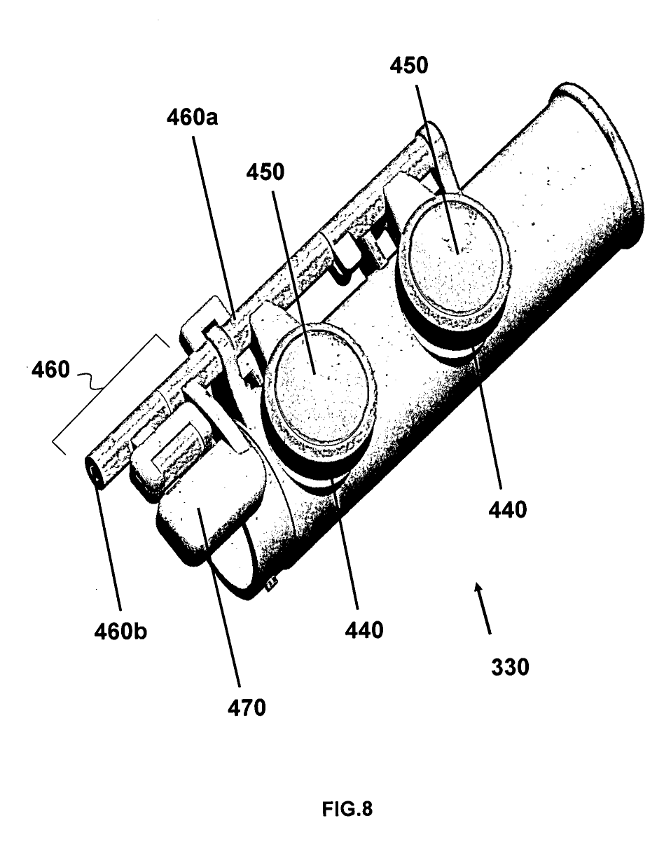

The elongate barrel of the flute (300) further consists of a main body (320) as shown in FIGS. 5(a)-(f) and FIG. 6, a head joint (310) upon which the embouchure hole (340) is disposed, and a foot joint (330) as shown in FIGS. 7(a)-(f) and FIG. 8 which includes an additional 2 keys and corresponding tone holes to enable playing of additional notes when the foot joint (330) is connected to the main body (320).

The lip plate (100) includes a curved surface (110) with a hole (120) disposed in it which substantially overlays upon the embouchure hole (340) of the flute (300) when the lip plate (100) is releasably attached to the elongate barrel of the flute (300).

The lip plate (100) also includes an air guide (130) on a non-barrel engaging surface of the lip plate (100). When the lip plate (100) is releasably attached to the elongate barrel of the flute (300) a second end (140) of the air guide is positioned adjacent the embouchure hole (340) whereby it is able to direct a stream of air from a user's mouth, blowing into a first end (150) of the air guide (130), in a direction relative to the embouchure hole (340) so that the flute (300) is able to be played.

The air guide (130) includes a tubular configuration as shown in FIG. 2. This tubular configuration alleviates the extent to which the user is required to form an embouchure with his/her own mouth and lips when playing the flute (300). This is considered particularly useful for beginner players as the formation of an embouchure is a difficult task initially.

As the user's proficiency in playing the flute (300) improves and the ability to form a suitable embouchure with the mouth and lips develops, the first embodiment lip plate (100) may be replaced with a standard configuration releasably detachable lip plate (190) such as is shown in FIGS. 3, 4 and 12 for use with the flute whereby the air stream from the user's mouth is directed at the embouchure hole (340) entirely based on the user's skill and proficiency in forming a suitable embouchure for playing the flute (300).

It is proposed that several different lip plates in accordance with the first embodiment could be packaged in a kit form with each of the lip plates providing air guides of varying configurations for use depending upon the specific proficiency of the user. For the beginner user, the tubular-shaped configuration may be initially used due to its ability to more easily direct the air stream towards the embouchure hole with minimal involvement of the user's facial muscles and shaping of the lips to form an embouchure suitable for blowing air at the embouchure hole. A lip plate having a U-shaped configuration of the air guide may be provided for intermediate level users whereby the user's increased involvement in forming a suitable embouchure is required in combination with the U-shaped configuration of the air guide. Additionally, for the more advanced user, a standard configuration lip plate (190) is provided which is releasably attachable to the flute (300) whereby the embouchure is required to be formed solely by the user without the assistance of an air guide (130).

The first embodiment lip plate (100) includes a recess (160) disposed beneath the air guide (130) which is configured to substantially complement a shape contour of the user's lip when the user's mouth is engaged with the first end (150) of the air guide (130). Accordingly, this recess (160) assists in providing a more ergonomic engagement of the user's mouth with the lip plate (100) in use.

The lip plate (100) is injection moulded from a polymer resin such as Acrylonitrile butadiene styrene or Polyoxymethylene material. In this embodiment, the lip plate (100) and the air guide (130) are integrally formed injection moulded polymer resin. In alternative embodiments it is possible for the lip plate (100) and air guide (130) to be formed separately and then joined together for instance by use of an adhesive.

In yet alternative embodiments the air guide (130) can be provided as a stand-alone accessory and retro-fitted to existing standard configuration lip plates (190) of flutes.

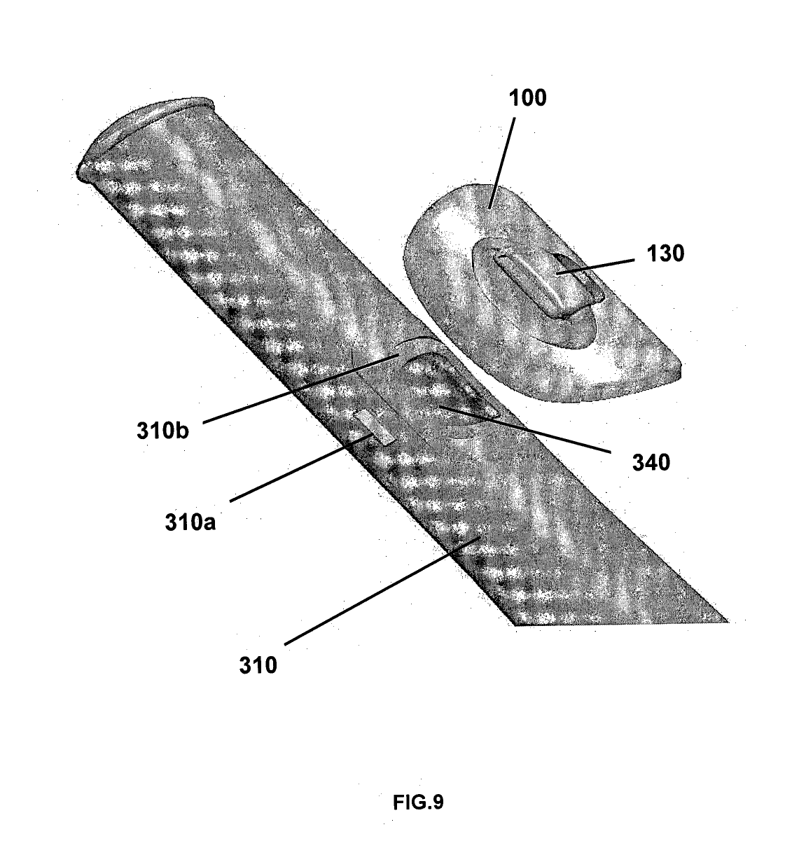

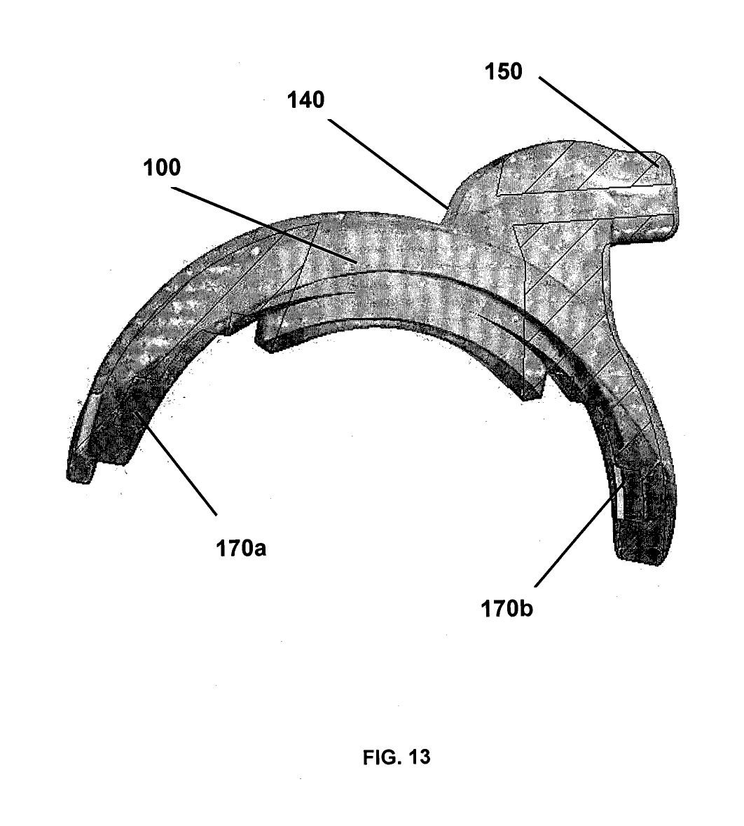

The lip plate (100) includes a releasable attachment means for releasably attaching the lip plate (100) to the elongate barrel of the flute (300). In this embodiment, as shown in FIG. 13, the releasable attachment means includes a pair of grooves (170a,170b) disposed on a barrel-engaging surface of the lip plate (100) which are adapted to receive in snap-fitting fashion a pair of corresponding protrusions (310a) extending from the elongate barrel on either side of the barrel adjacent the embouchure hole (340) as shown in FIGS. 9, 10 and 12.

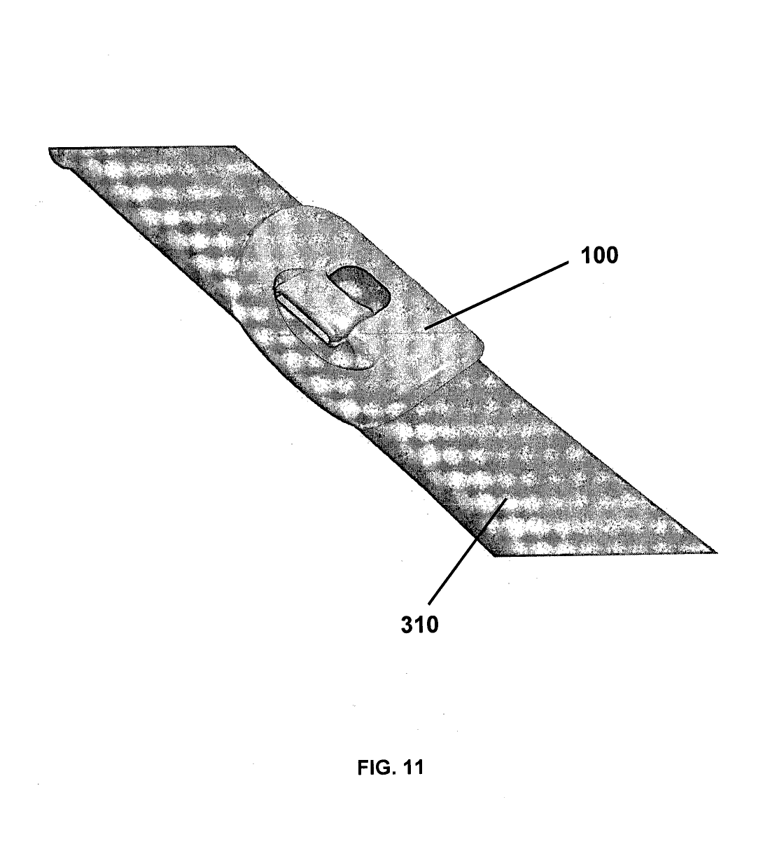

The releasable attachment means also assists in locating the lip plate (100) in a fixed position relative to the elongate barrel of the flute (300) such that the air guide (130) is able to direct the air stream from the user's mouth in a substantially fixed direction relative to the embouchure hole (340) on each occasion the flute (300) is being played without readjustment of the air guide (130) being required. The first embodiment lip plate (100) is shown being releasably attached to the head joint (310) in FIG. 11.

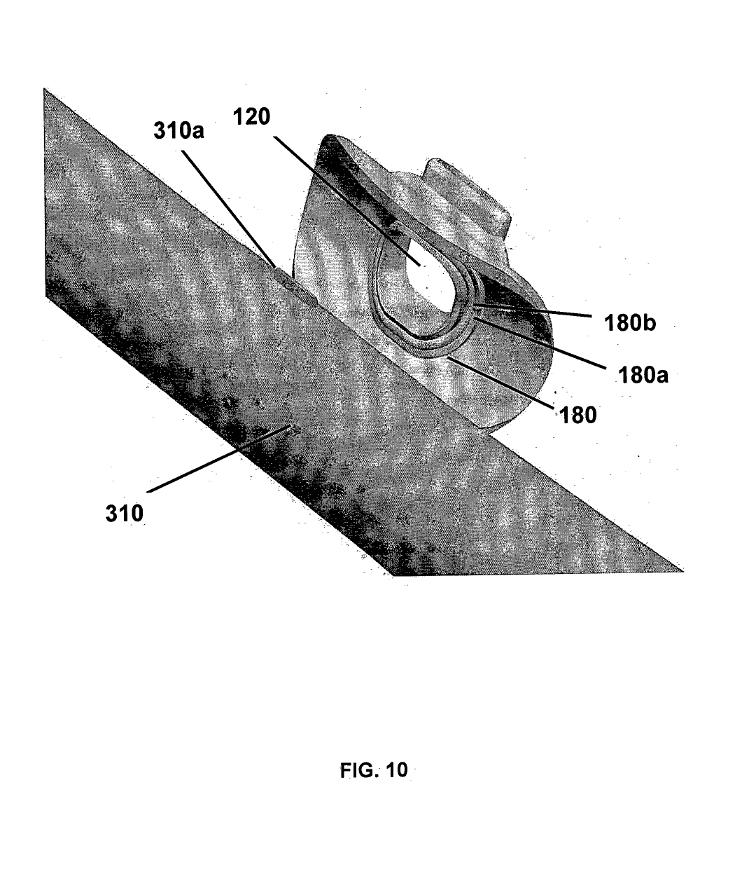

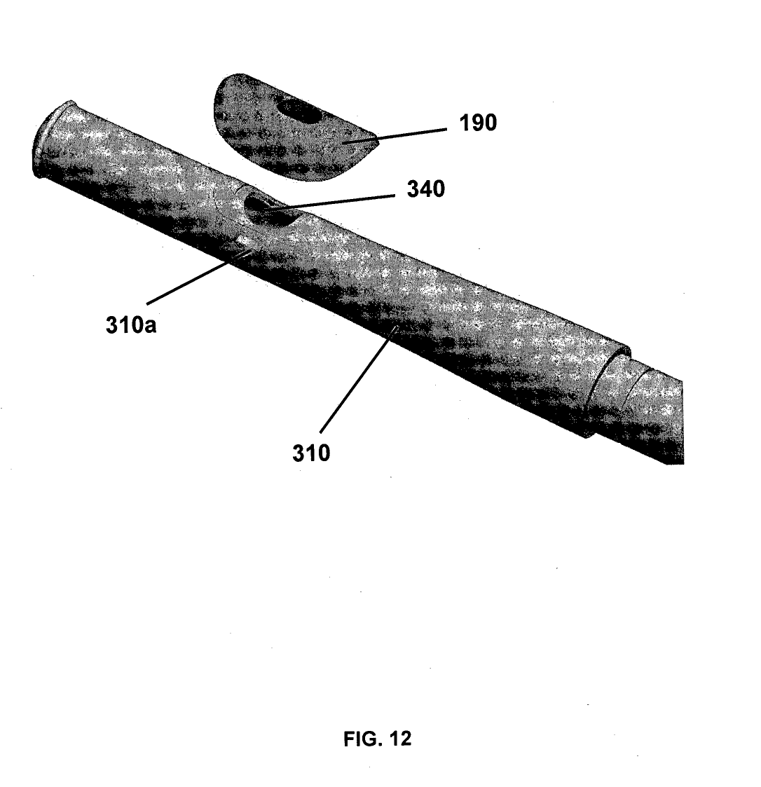

As shown in FIG. 10, the locating means is also provided by an annular protrusion (180) disposed around the hole (120) in the lip plate (100) on the barrel-engaging surface of the lip plate (100). The annular protrusion (180) is adapted for being received by a corresponding shaped recess (310b) disposed on the elongate barrel around a periphery of the embouchure hole (340) as shown in FIGS. 9 and 12 such that when the lip plate (100) is attached, the annular protrusion (180) fits neatly within the corresponding recess (310b) to alleviate relative movement between the lip plate (100) and the elongate barrel of the flute (300). During attachment, the hole (120) in the lip plate (100) overlays neatly over the embouchure hole (340) disposed in the elongate barrel of the flute (300).

As shown in FIG. 10, the annular protrusion (180) also includes an annular channel (180a) which is adapted for receiving an o-ring (180b) by frictional fitting. The o-ring (180b) provides an air-tight seal at the interface between the barrel-engaging surface of the lip plate (100) and the surface of the elongate barrel of the flute (300) when the lip plate (100) is attached. The o-ring (180b) is able to be easily replaced by dislodging the o-ring form the annular channel (180a) as required.

In yet a further embodiment of the present invention, a flute (300) is provided as shown in the drawings which includes an elongate barrel, an embouchure hole (340) disposed in a surface of the barrel, a plurality of tone holes (350) disposed along a surface of the barrel and a plurality of corresponding keys (360) operable by the user to selectively open and close the plurality of tone holes (350).

The flute (300) is formed from by injection moulding a polymer resin such as Acrylonitrile butadiene styrene and a Polyoxymethylene material and includes a main body (320), a head joint (310) releasably attachable to a first end of the main body (320), and, a foot joint (330) releasably attachable to a second end of the main body (320). The embouchure hole (340) is disposed on the head joint (310) in this embodiment.

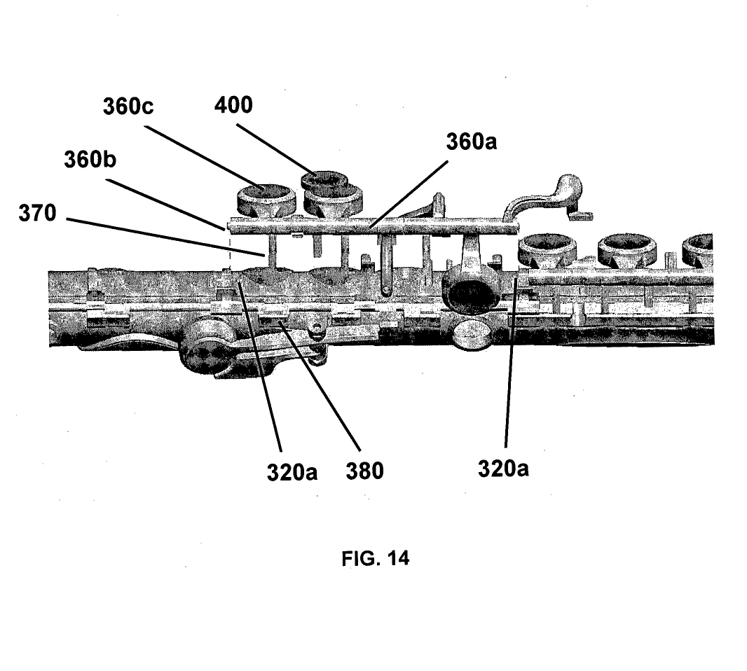

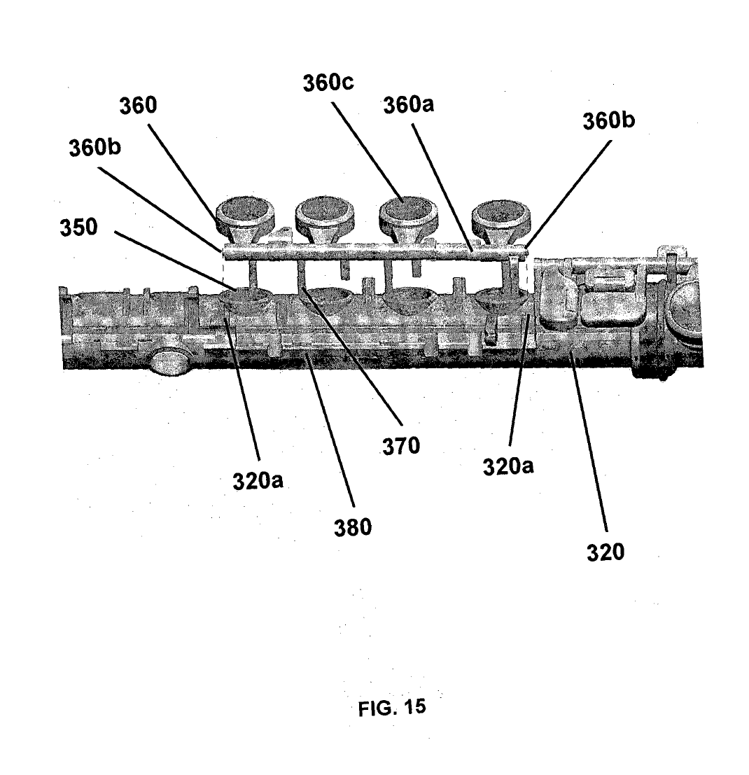

The plurality of keys (360) are also formed from a polymer resin and are releasably attachable to the elongate barrel of the flute (300). As shown in FIGS. 14 and 15, the releasable attachment means include pivot rods (360a) having tabs (360b) disposed on ends of the pivot rods (360a) that are adapted for snap fitting attachment into notches (320a) disposed on the elongate barrel. When attached, the keys (360) are able to pivot between the opened and closed positions relative to the corresponding tone holes (350). It would be appreciated by a person skilled in the, art that the attachment of the keys (360) to the elongate barrel of the flute (300) in this manner does not require skilled assembly by a technician and is achieved quickly and simply even by a child. Conversely, the keys (360) are also able to be easily and expediently detached from the elongate barrel of the flute (300) for cleaning or repair by simply urging the tabs (360b) of the pivot rods (360a) from the corresponding notches (320a).

The plurality of keys (360) are also biased into opened positions relative to the corresponding tone holes (350) by a biasing means which in this embodiment includes polymer resin arms (370) which extend from each of the plurality of keys (360). When the plurality of keys (360) are attached to the elongate barrel, the polymer resin arms (370) are received into slots (380) disposed in the elongate barrel. Accordingly, when a key (360) is depressed and released by the user during playing of the flute (300), the respective polymer resin arm (370) in the slot (380) is configured to provide a return force to urge the key (360) back into the opened position relative to its corresponding tone hole (350). In this embodiment, the polymer resin arms (370) of the plurality of keys (360) are integrally formed with each of the plurality of keys (360). However, it is conceivable that in alternative embodiments, the polymer resin arms (370) could be formed in stand alone fashion and fitted to the plurality of keys (360) to provide the biasing means. Conversely, the polymer resin arms (370) could be integrally formed with and extending from the elongate barrel of the flute (300) with the corresponding receiving slots (380) being disposed on the plurality of keys (360) to provide a similar biasing effect.

The plurality of keys (360) also include rubber pads (not shown) which provide substantially air tight seals when the corresponding tone holes (350) are closed by the keys (360). The rubber pads include circular shaped configurations substantially matching a shape and dimension of the respective keys (360) to which they are attached.

The rubber pads also include tails (390a) extending centrally therefrom which are adapted for friction fitting in a slot (390b) extending centrally through each of the plurality keys. The key pads and tails (390a) are integrally formed by injection moulding TPE rubber.

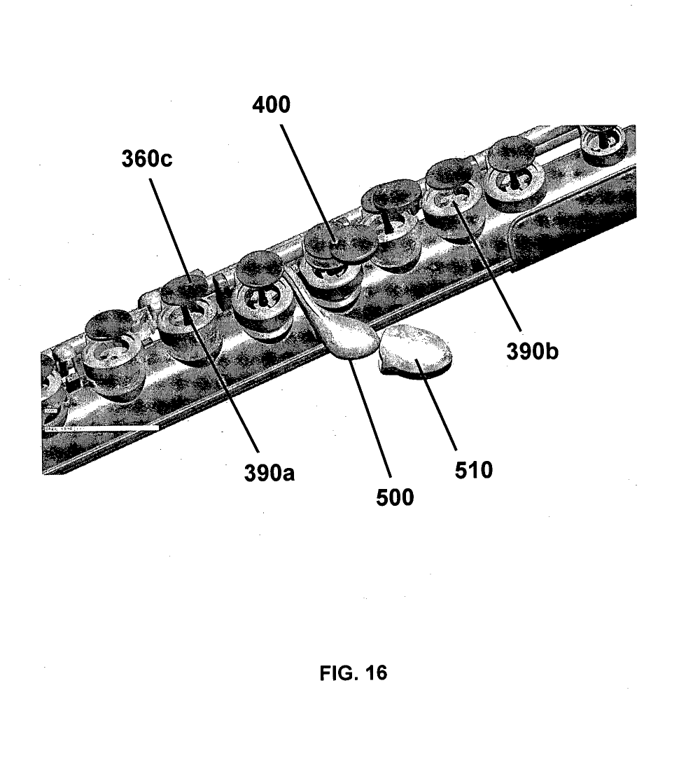

When a rubber pad has deteriorated and requires replacement, it can be simply dislodged from its respective key (360) by simply urging the rubber pad away form the key whereby the tail (390a) is withdrawn from the slot (390b) in the key (360). A new rubber pad can thereafter be attached to the key (360) by threading the tail (390a) into the slot (390b) as outlined above. FIG. 16 show the tails (390a) of rubber key pads extending through the slots (390b) in the keys.

The keys (360) also include releasably attachable caps (360c) adapted for contacting with the user's fingers when the keys (360) are operated during playing of the flute (300). The caps (360c) are releasably attached to the keys (360) by any suitable means including friction fitting, snap-fitting or screw-thread type attachment. The caps (360c) conceal a recess within the keys (360) which are able to house inserts having indicia indicative of colours, alphanumeric symbols, musical note symbols and so on which could be aesthetically appealing to users of the flute (300), such as children, and/or which may be intended for educational/instructional purposes in learning to play the flute (300). In embodiments where such inserts are used, it is possible for the releasably attachable caps (360c) to be transparent so that the indicia on the inserts is visible through the caps (360c) of the keys (360).

The flute (300) also includes a releasably attachable key extension (400) for at least one of the keys (360). The key extension (400) is attachable to a key (360) in place of an existing cap (360c) and is adapted to releasably attach to the key (360) in similar fashion to that of the standard cap (360c). However, the extension key (400) is shaped and dimensioned to offset the key (360) so as to reduce the distance the user's fingers are required to reach the key (360) during playing of the flute (300). The key extension (400) also assists in alleviating the uncomfortable and awkward contortion of the user's hand when playing the particular key (360).

To use the key extension (400), the existing cap (360c) of the key (360) is removed and the key extension (400) is fitted to the key (400) in place of the cap (360c) using a similar releasable attachment means to that of the cap (360c). As the user's proficiency with playing the flute (300) increases, the key extension (400) can be removed and replaced with a regular cap (360c). FIGS. 14 and 16 depict an example of key extensions (400) in use for round keys. A “pinky” key (500) of the flute (300) is also provided with a key extension (510) which is configured to slidably attach with the pinky key (500) in friction-fitting engagement s shown in FIG. 16.

It would be understood by a person skilled in the art that the existing caps (360c) and key extensions (400) described herein could also include indicia indicative of colours, alphanumeric symbols, musical note symbols and so on which could be aesthetically appealing to users of the flute (300), such as children, and/or which may be intended for educational/instructional purposes in learning to play the flute (300).

In this embodiment, the elongate barrel of the flute (300) does not include a fixed lip plate adjacent the embouchure hole and is adapted for use with the first embodiment lip plate (100) described above. It would be appreciated that in alternative embodiments a lip plate could be fixed to the head joint (310).

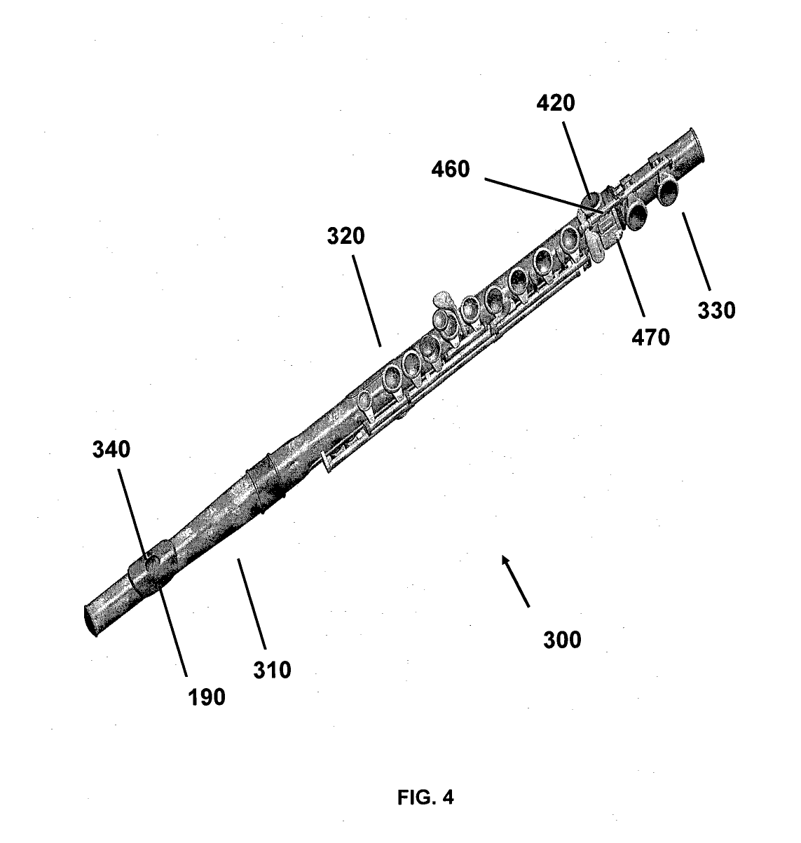

The main body (320) of the elongate barrel also includes a tone hole and corresponding key (420) as shown in FIGS. 4 and 6 which are adapted for enabling playing of a D# note without the use of the foot joint being attached. Accordingly, as the tone hole and key (420) for playing the D# note is now provided on the main body of the flute embodiment instead of the foot joint, a child and/or beginner is able to practice playing the flute without incurring additional time and complexity in connecting the foot joint (330) to the main body (320). Furthermore, the child and/or beginner can play the D# note using only the main body (320) without having to bear the additional weight of a foot joint (which may be particularly heavy and cumbersome for handling by a child).

In embodiments of the present invention, the main body (320) and the foot joint (330) are releasably attachable using a bayonet-fit type attachment means. As shown in FIG. 4, the relative positioning and layout of the combined keys (360) and key work (460) of the main body (320) and foot joint (330) when attached are substantially consistent with and resemble that of an attached main body and foot joint in a conventional flute. Importantly, this ensures that a child and/or beginner's ability to practice proper finger placement and key handling, as would be expected when playing a conventional metal flute, is not compromised.

As the D# key (420) is now located on the main body (320) instead of the foot joint (330), the foot joint (330) is configured with some key work (460) overhanging an end of the foot joint (330) as shown in FIG. 8. The overhanging key work (460) includes a pinky key (470) and a pivot rod (460a) having a notch (460b) disposed at a distal end. When the foot joint (330) is connected to the main body (320) and the overhanging key work (460) is rotated into position adjacent keys (360) and key work of the main body (320), a tab disposed on the main body (320) snap-fits into the notch (460b) disposed on the overhanging key work (460) so as to locate the pivot rod (460) of the overhanging key work (460) in position for pivotable movement. Additionally, the attachment means is suitably configured to control the degree of relative movement between the main body (320) and foot joint (330) when attachment is effected so that the combined keys (360) and key work (460) are suitably positioned relative to each other.

Certain conventional metal flutes also include a tone hole and corresponding key located on a main body to enable playing of a D# note without attachment of a foot joint. However, such metal flutes are not suited for attachment of a foot joint in the manner described above in order to accommodate a child and/or beginner's developing playing ability due to the susceptibility to damage that an overhanging key work made from relatively delicate and expensive metal material would be exposed to. Accordingly, the prevailing practice in conventional metal flute design and construction is either that a D# key is disposed on the main body without the option of attaching a foot joint, or, the D# note is retained entirely on the foot joint. Because such conventional metal flutes do not allow the option of attaching a foot joint, they become redundant once a child and/or beginner's playing proficiency improves and a foot joint is required for attachment in order to expand the range of notes that can be played. Ultimately, added expense is incurred in purchasing an entirely new flute which allows for suitable attachment of a foot joint in order to accommodate the child and/or beginner's developing playing ability.

Advantageously, as embodiments of the present invention described herein are formed from a polymer resin material, it is both cost effective and practicable to provide the foot joint (330) with overhanging key work (460) for attachment to a main body (320) having a D# key (420) due to the robustness and relatively low cost of the material. Moreover, as embodiments of the present invention provide the option of connecting the foot joint (330) to the main body (320), the child and/or beginner is provided with greater flexibility in expanding the range of notes that can be played with attachment of the foot joint (330) as playing proficiency improves. Accordingly embodiments of the present invention are less likely to become redundant compared to existing flutes having D# keys disposed on the main body.

In yet a further embodiment of the present invention, a main body of a flute is provided including a tone hole disposed on a surface of the main body, and a corresponding key operable by a user to selectively open and close the tone hole in order to play a D# note without attachment of a foot joint. In this particular embodiment, the main body of the flute need not necessarily include a polymer resin material but may also include any other suitable material such as a metal material.

It is also envisaged that in certain embodiments, releasably attachable lip plates could be provided having varying hole configurations such that when such lip plates are releasably attached to the flute the shape of the embouchure hole is able to be varied. Particularly where the releasably attachable lip plates are formed from polymer resin, such lip plates may enable a person to conveniently and cost-effectively experiment with different embouchure hole configurations to determine which such hole configuration may particularly suit the person's playing preference and ability. Releasably attachable lip plates which are formed from a polymer resin are relatively cost-effective and versatile and therefore well suited for this application. In contrast, modification and experimentation with different embouchure holes on traditional metal flutes tends to be expensive and time consuming due to the greater skill and precession involved in working the metal lip plate.

Advantageously, as embodiments of the present invention described herein are formed from polymer resin, making it more robust and less susceptible to damage, it is both cost effective and practicable to configure the foot joint with overhanging key work (460) suitable for positioning with the keys of the main body (320) to present a conventional key positioning and layout when the main body (320) and foot joint (330) are connected. Moreover, as embodiments of the present invention provide the option of connecting the foot joint (330) to the main body (320), this provides the child and/or beginner player with greater flexibility in expanding the range of notes that can be played on the flute as playing proficiency improves. As shown in the drawings, the foot joint (330) in this flute embodiment is provided with two tone holes (440) and two corresponding keys (450) which provide expanded playing range.

In yet a further embodiment of the present invention, a main body of a flute is provided including a tone hole disposed on a surface of the main body, and a corresponding key operable by a user to selectively open and close the tone hole in order to play a D# note without attachment of a foot joint. In this particular embodiment, the main body of the flute need not necessarily include a polymer resin material but may also include any other suitable material such as a metal material.

It is also envisaged that in certain embodiments, releasably attachable lip plates could be provided having varying hole configurations such that when such lip plates are releasably attached to the flute the shape of the embouchure hole is able to be varied. Particularly where the releasably attachable lip plates are formed from polymer resin, such lip plates may enable a person to conveniently and cost-effectively experiment with different embouchure hole configurations to determine which such hole configuration may particularly suit the person's playing preference and ability. Releasably attachable lip plates which are formed from a polymer resin are relatively cost-effective and versatile and therefore well suited for this application. In contrast, modification and experimentation with different embouchure holes on traditional metal flutes tends to be expensive and time consuming due to the greater skill and precession involved in working the metal lip plate.

Those skilled in the art will appreciate that the invention described herein is susceptible to variations and modifications other than those specifically described without departing from the scope of the invention. All such variations and modification which become apparent to users skilled in the art, should be considered to fall within the spirit and scope of the invention as broadly hereinbefore described. It is to be understood that the invention includes all such variations and modifications. The invention also includes all of the steps and features, referred or indicated in the specification, individually or collectively, and any and all combinations of any two or more of said steps or features.

The reference to any prior art in this specification is not, and should not be taken as, an acknowledgment or any form of suggestion that that prior art forms part of the common general knowledge.

1-17. (canceled)

18. A lip plate for a flute, the lip plate including an air guide positionable adjacent an embouchure hole of the flute when the lip plate is attached to the flute wherein the air guide is adapted for directing a stream of air from a user's mouth in a direction relative to the embouchure hole to enable the flute to be played.

19. A lip plate as claimed in claim 18 wherein the air guide includes at least one of a tubular and a U-shaped configuration.

20. A lip plate as claimed in claim 18 wherein the air guide includes a first end adapted for engagement with the user's mouth and a second end positionable adjacent the embouchure hole via which the air stream exiting the air guide is directed in the direction relative to the embouchure hole.

21. A lip plate as claimed in claim 18 including a surface configured to substantially complement a shape contour of a lip of the user when the user's mouth is engaged with the first end of the air guide.

22. A lip plate as claimed in claim 18 including a polymer resin material.

23. A lip plate as claimed in claim 22 wherein the polymer resin includes at least one of an Acrylonitrile butadiene styrene and a Polyoxymethylene material.

24. A lip plate as claimed in claim 18 including a releasable attachment means for releasably attaching the lip plate to the flute.

25. A lip plate as claimed in claim 24 wherein the releasable attachment means includes at least one of a snap-fitting attachment means, an adhesive attachment means, a friction-fitting attachment, a clamping attachment means, an elastic attachment means and a screw-thread type attachment means.

26. A lip plate as claimed in claim 25 wherein the snap-fitting attachment means includes a groove adapted for receiving a protrusion disposed on the flute so as to releasably attach the lip plate to the flute.

27. A lip plate as claimed in claim 18 wherein the lip plate is adapted for releasable attachment to a head joint of the flute upon which the embouchure hole of the flute is located.

28. A lip plate as claimed in claim 27 including a locating means for locating the lip plate in a substantially fixed position relative to the flute when the lip plate is releasably attached to the flute.

29. A lip plate as claimed in claim 28 wherein the locating means includes the releasable attachment means.

30. A lip plate as claimed in claim 28 wherein the locating means includes a protrusion extending from the lip plate, the protrusion being shaped to substantially complement a contour of a recess disposed on the flute.

31. A lip plate as claimed in claim 30 wherein the protrusion includes an annular channel adapted for receiving an o-ring, the o-ring providing an air-tight seal between the lip plate and the flute when the lip plate is releasably attached to the flute.

32-64. (canceled)

65. A lip plate for a flute, the lip plate including an air guide positionable adjacent an embouchure hole of the flute when the lip plate is attached to the flute wherein the air guide is adapted for directing a stream of air from a user's mouth in a direction relative to the embouchure hole to enable the flute to be played,
wherein the air guide includes at least one of a tubular and a U-shaped configuration and includes a first end adapted for engagement with the user's mouth and a second end positionable adjacent the embouchure hole via which the air stream exiting the air guide is directed in the direction relative to the embouchure hole; and
wherein the lip plate includes a surface configured to substantially complement a shape contour of a lip of the user when the user's mouth is engaged with the first end of the air guide; and
wherein the lip plate includes a polymer resin material, which includes at least one of an Acrylonitrile butadiene styrene and a Polyoxymethylene material; and
wherein the lip plate includes a releasable attachment means for releasably attaching the lip plate to the flute, which includes at least one of a snap-fitting attachment means, an adhesive attachment means, a friction-fitting attachment, a clamping attachment means, an elastic attachment means and a screw-thread type attachment means and the snap-fitting attachment means includes a groove adapted for receiving a protrusion disposed on the flute so as to releasably attach the lip plate to the flute; and
wherein the lip plate is adapted for releasable attachment to a head joint of the flute upon which the embouchure hole of the flute is located and includes a locating means for locating the lip plate in a substantially fixed position relative to the flute when the lip plate is releasably attached to the flute, which includes the releasable attachment means and includes a protrusion extending from the lip plate, the protrusion being shaped to substantially complement a contour of a recess disposed on the flute, which includes an annular channel adapted for receiving an o-ring, the o-ring providing an air-tight seal between the lip plate and the flute when the lip plate is releasably attached to the flute.

66. A lip plate as claimed in claim 19 wherein the air guide includes a first end adapted for engagement with the user's mouth and a second end positionable adjacent the embouchure hole via which the air stream exiting the air guide is directed in the direction relative to the embouchure hole.

67. A lip plate as claimed in claim 19 including a surface configured to substantially complement a shape contour of a lip of the user when the user's mouth is engaged with the first end of the air guide.

68. A lip plate as claimed in claim 20 including a surface configured to substantially complement a shape contour of a lip of the user when the user's mouth is engaged with the first end of the air guide.

69. A lip plate as claimed in claim 19 including a polymer resin material.

70. A lip plate as claimed in claim 20 including a polymer resin material.
